(19) United States
(12) Patent Application Publication
(10) Pub. No.: US 2005/0105732 A1
(43) Pub. Date: May 19, 2005

(54) Systems and methods for delivering pre-encrypted content to a subscriber terminal

(76) Inventors: George T. Hutchings, Doylestown, PA (US); Douglas S. Makofka, Willow Grove, PA (US); Lawrence D. Vince, Lansdale, PA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/988,228

(22) Filed: Nov. 12, 2004

Related U.S. Application Data
(60) Provisional application No. 60/520,695, filed on Nov. 17, 2003.

(51) Int. Cl. H04L 9/00; H04K 1/00

(52) U.S. Cl. 380/255; 713/168

(57) ABSTRACT

An exemplary content delivery system for delivering pre-encrypted content to a first subscriber terminal includes an off line encryption system configured to generate the pre-encrypted content using a control word, a caching system configured to store the pre-encrypted content and transmit the pre-encrypted content to the first subscriber terminal, a first conditional access system configured to allow a number of subscriber terminals to decrypt the pre-encrypted content, a second conditional access system configured to allow the first subscriber terminal to decrypt the pre-encrypted content, and a first encryption renewal system associated with the first conditional access system. The first encryption renewal system is configured to authorize the second conditional access system to allow the first subscriber terminal to decrypt the pre-encrypted content. An exemplary method for delivering pre-encrypted content to a first subscriber terminal includes generating the pre-encrypted content using a control word, transmitting the pre-encrypted content to the first subscriber terminal, and using an encryption renewal system associated with a first conditional access system to authorize a second conditional access system to allow the first subscriber terminal to decrypt the pre-encrypted content.

### BACKGROUND

Recent advances in cable and satellite distribution of subscription and “on-demand” audio, video and other digital content to subscribers have given rise to a growing number of digital set-top boxes (STBs) (sometimes referred to as Digital Consumer Terminals or “DCTs”) for decoding and delivering digitally broadcast programming. As the market for digital multimedia content of this type grows and matures, there is a corresponding growth of demand for new, more advanced features.

Video-on-demand (VOD) and audio-on-demand are examples of features made practical by broadband digital broadcasting via cable and satellite. Unlike earlier services where subscribers were granted access to scheduled encrypted broadcasts (e.g., movie channels, special events programming, pay per view purchases, etc.), these on-demand services permit a subscriber to request a desired video, audio or other program at any time and to begin viewing the content at any point therein. Upon receiving the request for programming (and, presumably, authorization to bill the subscriber's account), the service provider then transmits the requested program to the subscriber's set-top box for viewing/listening.

Systems for ensuring that, in a pay or subscription broadcast system, only those who have paid to receive broadcast content actually do receive the broadcast content are known in the art. Such a system is known as a conditional access system (“CA system” or “CAS”). Typically, pay broadcast systems generally broadcast encrypted material and utilize a CAS to deliver one or more appropriate decryption keys to authorized receivers only.

One area of concern, especially for direct content providers and movie companies, is secure delivery of content to an STB. Content delivery often occurs over data backbones, satellite networks, cable networks, and the Internet. The method by which content is produced and delivered to consumers is constantly changing. There is a constant risk of hackers being able to hack into a content delivery system and obtain digitally perfect copies of the content.

### SUMMARY

An exemplary content delivery system for delivering pre-encrypted content to a first subscriber terminal includes an off line encryption system configured to generate the pre-encrypted content using a control word, a caching system configured to store the pre-encrypted content and transmit the pre-encrypted content to the first subscriber terminal, a first conditional access system configured to allow a number of subscriber terminals to decrypt the pre-encrypted content, a second conditional access system configured to allow the first subscriber terminal to decrypt the pre-encrypted content, and a first encryption renewal system associated with the first conditional access system. The first encryption renewal system is configured to authorize the second conditional access system to allow the first subscriber terminal to decrypt the pre-encrypted content.

exemplary method for delivering pre-encrypted content to a first subscriber terminal includes generating the pre-encrypted content using a control word, transmitting the pre-encrypted content to the first subscriber terminal, and using an encryption renewal system associated with a first conditional access system to authorize a second conditional access system to allow the first subscriber terminal to decrypt the pre-encrypted content.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 illustrates an exemplary content delivery system that may be used to pre-encrypt and deliver content to a set-top box (STB) according to principles described herein.

FIG. 2 illustrates an exemplary content delivery system wherein multiple CA systems control access to the same pre-encrypted content according to principles described herein.

FIG. 3 illustrates an alternative content delivery system wherein multiple CA systems control access to the same pre-encrypted content according to principles described herein.

FIG. 4 shows a first content delivery system and a second content delivery system configured to share the same pre-encrypted content according to principles described herein.

FIG. 5 is a flow chart illustrating an exemplary method of allowing multiple CA systems to control the access of one or more STBs to pre-encrypted content according to principles described herein.

Throughout the drawings, identical reference numbers designate similar, but not necessarily identical, elements.

### DETAILED DESCRIPTION

Systems and methods for delivering pre-encrypted content to one or more subscriber terminals whose access to the pre-encrypted content is controlled by two or more conditional access (CA) systems are described herein. An off line encryption system generates the pre-encrypted content using a control word. A caching server stores the pre-encrypted content and transmits the pre-encrypted content to the STB. An encryption renewal system associated with a first conditional access system authorizes a second conditional access system to allow one or more subscriber terminals to decrypt the pre-encrypted content.

In the following description, for purposes of explanation, numerous specific details are set forth in order to provide a thorough understanding of the present system and method. It will be apparent, however, to one skilled in the art that the present system and method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

The term “content” will be used herein and in the appended claims, unless otherwise specifically denoted, to refer to any digital information that may be delivered to a subscriber terminal such as a set-top box (STB), personal computer, mobile phone, or the like. The content may include, but is not limited to, video on demand (VOD), audio on demand, and other digital multimedia content. The content may be delivered via any suitable data network including, but not limited to, a satellite network, a cable network, a cellular wireless network, or the Internet. The terms “subscriber terminal” and “set-top box” will be used herein and in the appended claims, unless otherwise specifically denoted, to refer to any electronic component configured to receive content.

As mentioned, there is a need for secure delivery of content to legitimate subscribers or customers. A system operator generally encrypts content that is sent over a network to an STB. A content provider often encrypts content in real time as the content is transmitted to the customer. However, in some instances, real time encryption is not desirable or feasible. Hence, in some embodiments, a content provider encrypts the content before the content is transmitted to the STB. The encryption of content before the content is transmitted is called off-line encryption or pre-encryption. Pre-encryption often reduces cost and overhead associated with real time encryption.

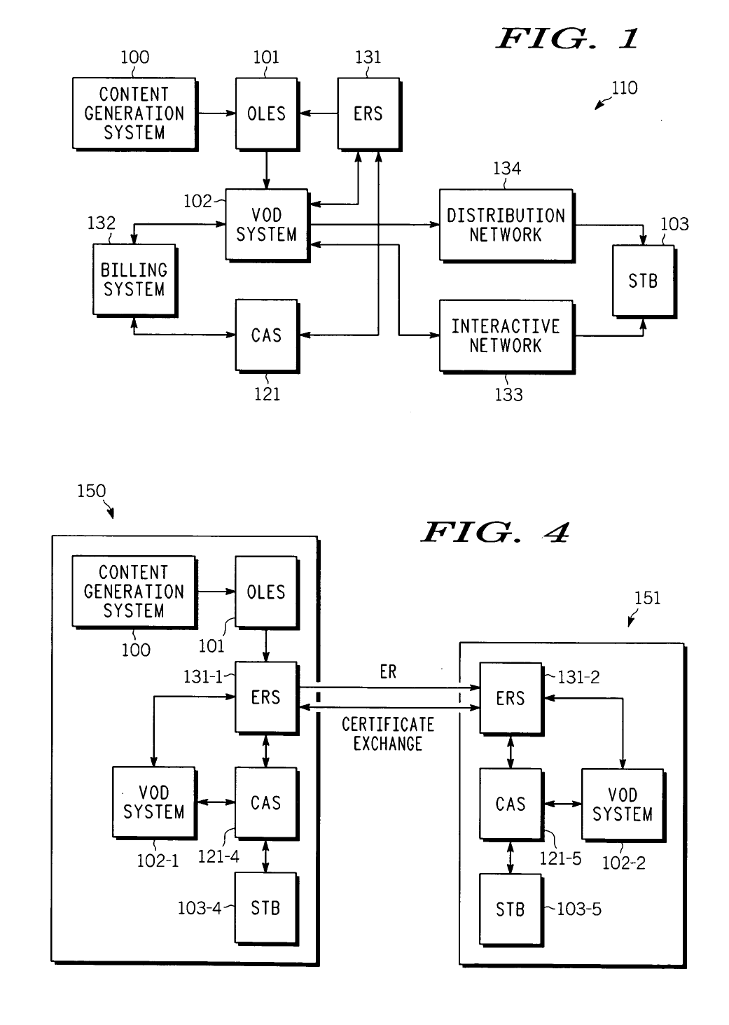

FIG. 1 illustrates an exemplary content delivery system (110) that may be used to pre-encrypt and deliver content to an STB (103). An STB (103) will be used in the following examples as an exemplary subscriber terminal. It will be recognized that the STB (103) may be any type of subscriber terminal. Among other components, the content delivery system (100) comprises a content generation system (100) for generating clear content, an off line encryption system (OLES) (101) for pre-encrypting the content, a video on-demand (VOD) system (102) for storing the pre-encrypted content and for distributing the pre-encrypted content to the STB (103) on an on-demand basis, a conditional access system (CAS) (121) for controlling one or more keys granting access to pre-encrypted content, an encryption renewal system (ERS) (131) for accepting requests from the VOD system (102) to generate new entitlement control messages (ECMs) for the pre-encrypted content, a distribution network (134) for facilitating delivery of the pre-encrypted content, and an interactive network (133) for providing two-way interaction between the subscriber and the VOD system (102). Additional or alternative components and arrangements for achieving the various functionalities of content delivery system (110) are possible.

In operation, the content generation system (100) generates clear content and inputs the clear content into the OLES (101). Clear content is content, such as a movie that is unencrypted. The OLES (101) encrypts the clear content using an encryption scheme that may or may be not known in the art. Encryption is the transformation of content using one or more keys into a form that is apparently unintelligible and extremely difficult, if not impossible, to access or decrypt without the key. A key may be a sequence of random or pseudorandom bits, for example. The use of keys to encrypt and decrypt content is known in the art. A key is also known as a control word. The OLES (101) pre-encrypts the content using one or more control words. However, for illustrative purposes, it will be assumed that the OLES (101) pre-encrypts the content using a single control word in the examples given herein. Hence, any reference to a “control word” means one or more control words.

OLES (101) also generates an encryption record (ER) associated with the pre-encrypted content. The ER is a data structure comprising the control word used to pre-encrypt the content. The ER may alternatively include information that allows the ERS (131), CAS (121), or other system to generate the control word used to pre-encrypt the content.

Once the clear content is pre-encrypted by the OLES (101), the resulting pre-encrypted content and associated ER are delivered to the VOD system (102) for storage. The VOD system (102) is configured to keep the pre-encrypted content and associated ER together. The VOD system (102) may be any system or server configured to store and distribute pre-encrypted VOD content and/or any other type pre-encrypted content to one or more STBs (103). The VOD system (102) is also referred to as a “VOD server,” a “caching system,” or a “caching server.”

Before the pre-encrypted content may be requested or viewed by subscribers, the VOD system (102) submits a request for an entitlement control message (ECM) to the ERS (131). The request includes the ER corresponding to the desired pre-encrypted content. The ECM is an encrypted form of the control word used to pre-encrypt the content and is CAS-specific. In other words, the ECM is generated in a way such that only STBs (103) controlled by the authorized CAS (121) may decrypt the ECM and obtain the control word needed to decrypt the pre-encrypted content. The ECM is cryptographically protected using a key (typically periodical) provided by the CAS (121). It will be recognized that the ECM may be referred to by a different name may be generated using any encryption scheme.

The ERS (131) responds to the ECM request by transmitting the ECM to the VOD system (102). Upon receiving a content request from the STB (103), the VOD system (102) transmits the pre-encrypted content and the corresponding ECM to the STB (103). In some embodiments, the ECM returned to the VOD system (102) by the ERS (131) is valid and useable with the pre-encrypted content only for a limited time as determined by the CAS (121).

As mentioned, the CAS (121) is included in the content delivery system (110) to prevent unauthorized STBs from receiving and/or decrypting the pre-encrypted content. In operation, the CAS (121) is configured to generate and send a subscriber authorization message to the STB (103) if the STB (103) is authorized to receive and decrypt the pre-encrypted content. The subscriber authorization message will be referred to herein as an entitlement management message (EMM) for explanatory purposes. The EMM is specific to a particular subscriber or STB (103) and includes information authorizing the STB (103) to decode or decrypt the ECM, thereby giving the STB (103) access to the control word needed to decrypt the pre-encrypted content. Without the EMM, the STB (103) cannot decrypt the pre-encrypted content. In this manner, the CAS (121) may control the access of individual STBs (103) to the pre-encrypted content.

In some instances, the content delivery system (110) may include more than one CAS (121). Each CAS (121) may belong to a different vendor or entity, for example, and may have a number of corresponding subscribers for which each CAS (121) controls access to pre-encrypted content. In some embodiments, each CAS (121) is configured to control its respective subscribers' access to pre-encrypted content provided by a single content generation system (100) and pre-encrypted by a single OLES (101). Furthermore, each CAS (121) may control access to the pre-encrypted content in a distinct manner. In other words, each CAS (121) may generate and manage the keys used in encryption and decryption in a distinct manner. In some embodiments, each CAS (121) uses a common encryption scheme such as DVS042.

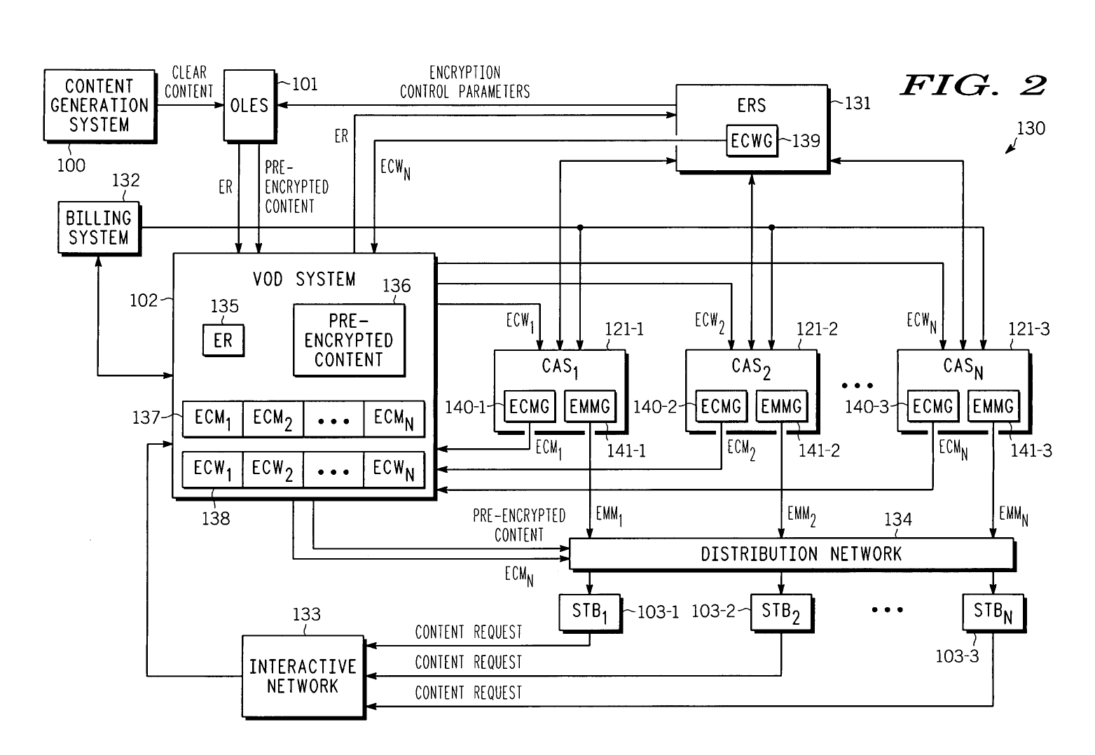

FIG. 2 illustrates an exemplary content delivery system (130) wherein multiple CA systems (121) control access to the same pre-encrypted content. The CA systems (121) are labeled CAS₁ through CAS_{N} in FIG. 2 to show that any number of CA systems (121) may be included in the content delivery system (130). As shown in FIG. 2, the content generation system (100) generates clear content that is input into the OLES (101). The OLES (101) pre-encrypts the content using a control word, embeds the control word in the ER, and transmits the pre-encrypted content and the ER to the VOD system (102). The ER and the pre-encrypted content may be transmitted simultaneously to the VOD system (102). Alternatively, the ER may be transmitted to the VOD system (102) prior to the transmission of the pre-encrypted content.

The VOD system (102) includes a first storage unit (135) configured to store the ER and a second storage unit (136) configured to store the pre-encrypted content (136). As will be described in more detail below, the VOD system (102) also includes third and fourth storage units (137, 138) configured to store a number of ECMs and encrypted control words (ECWs). The ECWs will be described in more detail below. The storage units (1335-138) may be any combination of volatile and non-volatile memory such as a hard drive and random access memory (RAM).

In some embodiments, the content delivery system (130) includes an encryption renewal system (ERS) (131). As will be explained in more detail below, the ERS (131) is a trusted authority configured to control which of the CA systems (121) may participate in the content delivery system (130). The STBs (103) associated with a CAS (121) authorized to participate in the content delivery system (130) may successfully receive and decrypt the pre-encrypted content. On the other hand, the STBs (103) associated with a CAS (121) that is not authorized to participate in the content delivery system (130) will not be able to receive and/or decrypt the pre-encrypted content.

As shown in FIG. 2, the VOD system (102) transmits the ER to the ERS (131). As explained previously, the ER includes information that permits a CAS (121) or other system to generate the control word used by the OLES (101) to pre-encrypt the clear content. Thus, the ERS (131) is configured to use the ER to generate the control word used by the OLES (101) to pre-encrypt the content. The ERS (131) may also transmit encryption control parameters to the OLES (101). These encryption control parameters may be used by the OLES (101) to pre-encrypt the content.

In addition, the ERS (131) is configured to generate one or more ECWs with an encrypted control word generator (ECWG) (139). An ECW is an encrypted version of the control word used to pre-encrypt the clear content. In some embodiments, the ERS (131) generates an ECW corresponding to each CAS (121) that participates in the content delivery system (130). Alternatively, the ERS (131) may generate a single ECW that is used by each CAS (121) that participates in the content delivery system (130). The ECW is also referred to as a covered control word.

As shown in FIG. 2, the ECWs are transmitted to the VOD system (102) and stored in storage unit (138). The ECWs prevent unauthorized users or hackers from obtaining the control word used to pre-encrypt the clear content if the ECWs are intercepted while being transmitted. As an added security measure, the ERS (131) may periodically generate a new ECW for each CAS (121) that participates in the content delivery system (130). These new ECWs are then transmitted to the VOD system (102) to replace the old ECWs stored in the storage unit (138).

As mentioned, the ERS (131) is configured to control which of the CA systems (121) may participate in the content delivery system (130). In some embodiments, the ERS (131) may be programmed or configured to authorize only certain CA systems (121) to participate in the content delivery system (130). Each CAS (121) shown in FIG. 2 is authorized to participate in the content delivery system (130) for illustrative purposes. The ERS (131) communicates with each authorized CAS (121) using a CAS authorization protocol. The CAS authorization protocol may be any communication protocol known in the art. If the ERS (131) authorizes a particular CAS (121) to participate in the content delivery system (130), the ERS (131) causes the ECW corresponding to the particular CAS (121) to be sent from the VOD system (102) to the particular CAS (121). The CAS (121) may then decrypt the ECW using one or more keys obtained in the authorization protocol to obtain the control word used to pre-encrypt the content. The CAS (121) then generates an ECM based on the control word and transmits the ECM to the VOD system (102) for storage in the storage unit (137).

In some embodiments, the CAS (121) has to be periodically reauthenticated with the ERS (131) via the CAS authorization protocol. If a CAS (121) becomes compromised or otherwise becomes unauthorized to distribute the pre-encrypted content, the ERS (131) is configured to cause the VOD system (102) to cease sending the ECW to the CAS (121). In this manner, the ERS (131) controls which of the CA systems (1210 may participate in the content delivery system (130).

As mentioned, the ECM is an encrypted form of the control word used to pre-encrypt the content. The term “ECM” will be used herein and in the appended claims, unless otherwise specifically denoted, to refer to any encrypted version of the control word used to pre-encrypt the content that is generated by a CAS (121). As shown in FIG. 2, each CAS (121) includes an ECM generator (ECMG) (140) configured to generate the ECM. Each ECM may be based on any CAS-specific criteria and the corresponding ECW. As will be explained in more detail below, the ECM is eventually used by one more of the STBs (103) to decrypt the pre-encrypted content.

In some embodiments, the CA systems (121) periodically regenerate the ECMs. These regenerated ECMs are transmitted to the VOD system (102) to replace the previously generated ECMs in the storage unit (137). In some alternative embodiments, the CA systems (121) are not configured to periodically regenerate the ECMs. In these alternative embodiments, each time a particular STB (103) makes a request for pre-encrypted content from the VOD system (102), the corresponding CAS (121) generates the ECM in real time based on an ECW provided by the VOD system (102). The CAS (121) then transmits the ECM to the VOD system (102). The exchange of information between the VOD system (102) and the CAS (121) that facilitates the real time generation of the ECM may be based on a digital video broadcasting (DBV) SimulCrypt protocol or any other key sharing protocol. SimulCrypt is a known protocol used in the art to share keys and other secret information between encryption systems.

Each CAS (121) also includes an EMM generator (141) configured to generate an EMM corresponding to an authorization from the CAS (121). The EMM includes information authorizing the STB (103) to decode or decrypt the corresponding ECM, thereby giving the STB (103) access to the control word needed to decrypt the pre-encrypted content. Without the EMM, the STBs (103) cannot decrypt the pre-encrypted content. In this manner, each CAS (121) may control the access of individual STBs (103) to the pre-encrypted content.

FIG. 2 shows that the pre-encrypted content, the ECMs, and the EMMs may be input into a distribution network (134). The distribution network (134) may be any network configured to distribute the pre-encrypted content, ECMs, and EMMs to one or more STBs (103). Each STB (103) may correspond to one or more of the CA systems (121). In other words, each CA system (121) is configured to control the access of one or more of the STBs (103) to the pre-encrypted content. For example, STB₁ (103-1) corresponds to CAS₁ (121-1), STB₂ (103-2) corresponds to CAS₂ (121-2), and STB_{N} (103-3) corresponds to CAS_{N} (121-3).

In some embodiments, any of the CA systems (121) may control the access of a particular STB (103) to the pre-encrypted content. For example, CAS₁ (121-1) and CAS₂ (121-2) may control the access of STB₁ (103-1) to the pre-encrypted content. In some alternative embodiments, the access of a particular STB (103) to the pre-encrypted content is controlled by a single CAS (121). For example, the access of STB₁ (103-1) to the pre-encrypted content may only be controlled by CAS₁ (121-1). In this instance, other CA systems (121) (e.g., CAS₂ (121-2)) cannot control the access of STB₁ (103-1) to the pre-encrypted content.

An STB (103) may send a request for pre-encrypted content to the VOD system (102) via an interactive network (133). The interactive network (133) may be the Internet or any other type of network. A billing system (132) may bill an account corresponding to the requesting STB (103) and generate a subscriber authorization message that is transmitted to the CAS (121) corresponding to the requesting STB (103). The CAS (121) may then give access to the requesting STB (103) by transmitting the corresponding EMM to the requesting STB (103) and by causing the VOD system (102) to transmit the requested pre-encrypted content and the corresponding ECM to the requesting STB (103). The STB (103) then decrypts the ECM using the authorization provided in the EMM. Finally, the STB (103) decrypts the pre-encrypted content using the decrypted control word.

For example, the ERS (131) may authorize CAS₁ (121-1) to participate in the content delivery system (130). The ERS (131) generates and transmits an encrypted control word (ECW₁) to the VOD system (102). The VOD system (102) stores ECWI in the storage unit (138). The VOD system (102) then sends ECWI to CAS₁ (121-1) which decrypts ECWI and generates an entitlement control message (ECMI) based on the decrypted control word. In some embodiments, CAS₁ (121-1) is the only CAS (121) configured to be able to decrypt ECW₁. The entitlement control message ECM, is then transmitted to the VOD system (102) and stored in the storage unit (137).

Any STB (103) associated with CAS₁ (121-1) may then request pre-encrypted content from the VOD system (102). For example, STB₁ (103-1) may request pre-encrypted content from the VOD system (102). If CAS₁ (121-1) authorizes STB₁ (103-1) to receive the requested pre-encrypted content, CAS₁ (121-1) transmits EMM₁ to STB₁ (103-1). The VOD system (102) also transmits the pre-encrypted content and ECM₁ to STB₁ (103-1). STB₁ (103-1) then decrypts ECM₁ using EMM₁ to acquire the control word used to pre-encrypt the content. The pre-encrypted content may then be decrypted by STB₁ (103-1) using the decrypted control word.

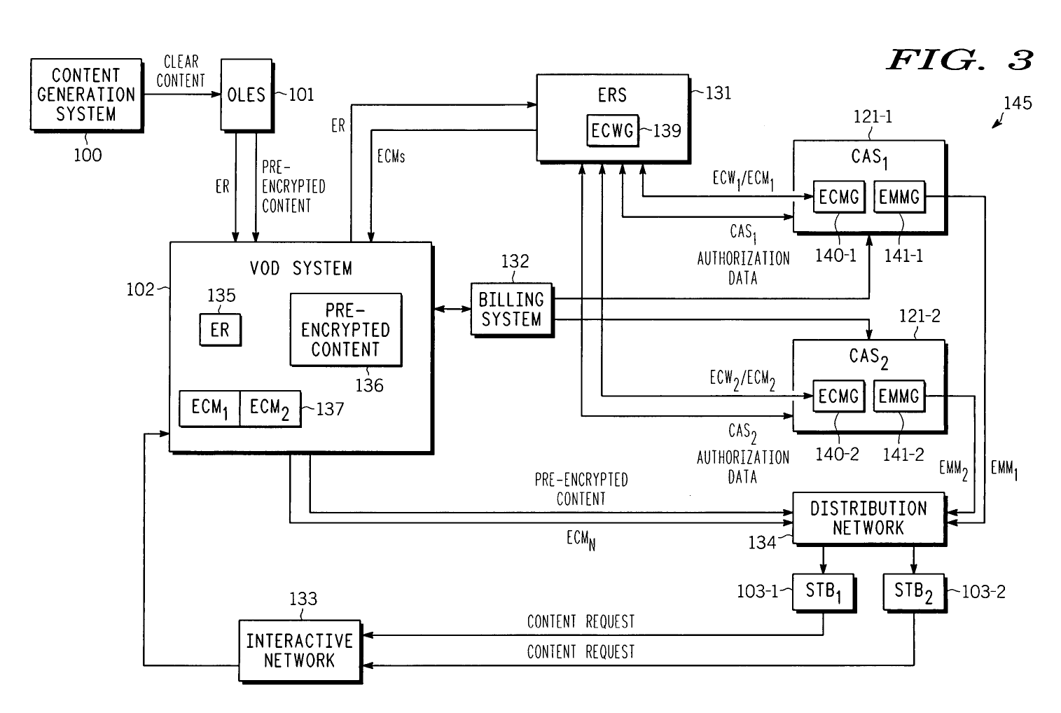

FIG. 3 illustrates an alternative content delivery system (145) wherein multiple CA systems (121) control access to the same pre-encrypted content. Two CA systems (121-1, 121-2) are shown for illustrative purposes only. It will be recognized that any number of CA systems (121) may be included in the content delivery system (145). Like the content delivery system (130) of FIG. 2, the content generation system (100) generates clear content that is input into the OLES (101). The OLES (101) pre-encrypts the content using a control word and transmits the pre-encrypted content and the ER to the VOD system (102). The VOD system (102) stores the ER in the first storage unit (135) and the pre-encrypted content in the second storage unit (136).

As shown in FIG. 3, the VOD system (102) transmits the ER to the ERS (131). The ERS (131) uses the ER to generate the control word used by the OLES (101) to pre-encrypt the content. The ERS (131) is also configured to generate an ECW for each participating CA system (121). The ECW is used by the ECMG (140) of each CA system (121) to generate a corresponding ECM. For example, the ECMG (140-1) generates a first ECM (ECM₁) that corresponds to CAS₁ (121-1). The authentication information required to generate the ECW and ECM is exchanged via an authenticated key exchange protocol executed between the CAS (121) and the ERS (131). The key exchange protocol may be an extended SimulCrypt protocol or any other key exchange protocol. The ERS (131) may be configured to periodically regenerate the ECW. Hence, the ECM may also periodically change.

As shown in FIG. 3, the ERS (131) may also exchange authorization data (CAS authorization data) with each authorized CA system (121). In this manner, the ERS (131) may control which CA system (121) participates in the content delivery system (145). The authorization data may be exchanged via any communication protocol known in the art. For example, the communication protocol may be the SimulCrypt or authenticated Diffie Hellman protocol.

Once the ECMs have been generated by the ECMGs (140), the ERS (131) transmits the ECMs corresponding to authorized CA systems (121) to the VOD system (102) to be stored in the storage unit (137). Each authorized CA system (121) also generates EMMs corresponding to the ECMs stored in the VOD system (102). The pre-encrypted content, ECMs, and EMMs may then be distributed to one or more STBs (103) as described in connection with FIG. 2.

FIG. 4 shows a first content delivery system (150) and a second content delivery system (151) configured to share the same pre-encrypted content. The first content delivery system (150) includes the content generation system (100) that generates the content and the OLES (101) that pre-encrypts the content. The first content delivery system (150) also includes a first ERS (131-1) configured to control the participation of a number of CA systems (121-4) in the first content delivery system (150). The first content delivery system (150) may also include, but is not limited to, a VOD system (102-1) and a number of STBs (103-4). The second content delivery system (151) includes a second ERS (131-2) configured to control the participation of a number of CA systems (121-5) in the second content delivery system (151). The second content delivery system (151) may also include, but is not limited to, a VOD system (102-2) and a number of STBs (103-5).

In some embodiments, the first ERS (131-1) transmits the ER generated by the OLES (101) to the second ERS (131-2) so that the second content delivery system (151) may use its own localized conditional access systems to secure access to the pre-encrypted content. As shown in FIG. 4, an interface (certificate exchange) based on a certificate authentication protocol may be used to allow the first ERS (131-1) to securely transfer to the second ERS (131-2) the information needed to uncover or decrypt the ER. The second ERS (131-2) may then generate the control word used to pre-encrypt the content and use its own encryption scheme to generate ECWs, ECMs, and/or other forms of the control word. The certificate authentication protocol may be any protocol such as, but not limited to, the SimulCrypt protocol or the X.509 certificate exchange and verification protocol.

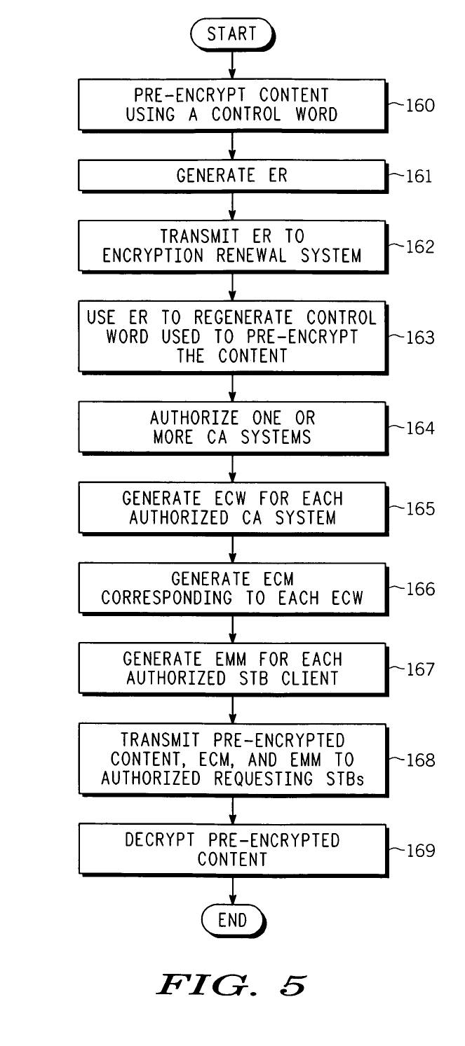

FIG. 5 is a flow chart illustrating an exemplary method of allowing multiple CA systems (121; FIG. 2) to control the access of one or more STBs (103; FIG. 2) to pre-encrypted content. The steps shown in FIG. 5 may be modified, removed, or added to as best serves a particular application. First, the content is pre-encrypted using a control word (step 160). An encryption record (ER) is also generated (step 161) and transmitted to the ERS (131; FIG. 2) (step 162). The ERS (131; FIG. 2) uses the ER to regenerate the control word used in step 160 to pre-encrypt the content (step 163).

shown in FIG. 5, the ERS (131; FIG. 2) also authorizes one or more CA systems (121; FIG. 2) to participate in the content delivery system (130; FIG. 2) (step 164). The ERS (131; FIG. 2) may perform this authorization by exchanging CAS authorization data with the CA systems (121; FIG. 2). Once the CA systems (121; FIG. 2) have been authorized, ECWs corresponding to each authorized CA system (121; FIG. 2) are generated (step 165). The CA systems (121; FIG. 2) may then generate ECMs corresponding to each ECW (step 166). The exchange of information between the ERS (131; FIG. 2) and the CA systems (121; FIG. 2) needed to facilitate the generation of the ECMs (step 166) may be performed using any key exchange protocol, e.g., SimulCrypt. The CA systems (121; FIG. 2) may also generate an EMM for each authorized STB (103; FIG. 2) (step 167). The EMMs, pre-encrypted content, and ECMs may then be transmitted to authorized requesting STBs (103; FIG. 2). The STBs (103; FIG. 2) may then decrypt the pre-encrypted content (step 169) using the information contained in the EMMs and ECMs.

The preceding description has been presented only to illustrate and describe embodiments of invention. It is not intended to be exhaustive or to limit the invention to any precise form disclosed. Many modifications and variations are possible in light of the above teaching. It is intended that the scope of the invention be defined by the following claims.

1. A content delivery system for delivering pre-encrypted content to a first subscriber terminal, said system comprising:
an off line encryption system configured to generate said pre-encrypted content using a control word;
a caching system configured to store said pre-encrypted content and transmit said pre-encrypted content to said first subscriber terminal;
a first conditional access system configured to allow a number of subscriber terminals to decrypt said pre-encrypted content;
a second conditional access system configured to allow said first subscriber terminal to decrypt said pre-encrypted content; and
a first encryption renewal system associated with said first conditional access system, said first encryption renewal system configured to authorize said second conditional access system to allow said first subscriber terminal to decrypt said pre-encrypted content.

2. The content delivery system of claim 1, wherein:
said off line encryption system further generates an encryption record corresponding to said control word; and
said encryption renewal system uses said encryption record to generate an encrypted control word corresponding to said second conditional access system, said encrypted control word being an encrypted version of said control word used to pre-encrypt said content.

3. The content delivery system of claim 2, wherein:
said encryption renewal system transmits said encrypted control word and information for decrypting said encrypted control word to said second conditional access system; and
said second conditional access system decrypts said encrypted control word and generates an entitlement control message, said entitlement control message being an encrypted form of said control word.

4. The content delivery system of claim 3, wherein said second conditional access system comprises an entitlement control message generator configured to generate said entitlement control message.

5. The content delivery system of claim 3, wherein said second conditional access system generates a subscriber authorization message, said subscriber authorization message comprising information for decrypting said entitlement control message.

6. The content delivery system of claim 5, wherein:
said entitlement control message and said subscriber authorization message are transmitted to said first subscriber terminal; and
said first subscriber terminal decrypts said pre-encrypted content using said entitlement control message and said subscriber authorization message.

7. The content delivery system of claim 5, wherein said subscriber authorization message is an entitlement management message.

8. The content delivery system of claim 2, wherein said encryption renewal system transmits said encryption record and said encrypted control word corresponding to said second conditional access system to said caching system, said caching system comprising one or more storage units for storing said encryption record and said encrypted control word.

9. The content delivery system of claim 8, wherein said encryption renewal system periodically regenerates said encrypted control word corresponding to said second conditional access system and transmits said regenerated encrypted control word to said caching system, wherein said caching system replaces said encrypted control word in said one or more storage units with said regenerated encrypted control word.

10. The content delivery system of claim 1, wherein said encryption renewal system authorizes said conditional access system to allow said first subscriber terminal to decrypt said pre-encrypted content by communicating with said second conditional access system using a key exchange protocol.

11. The content delivery system of claim 10, wherein said key exchange protocol is a SimulCrypt protocol.

12. The content delivery system of claim 1, further comprising a billing system configured to generate and transmit a subscriber authorization message to said second conditional access system, said subscriber authorization message authorizing said first subscriber terminal to decrypt said pre-encrypted content.

13. The content delivery system of claim 1, wherein said pre-encrypted content comprises pre-encrypted video-on-demand content.

14. The content delivery system of claim 1, wherein said encryption renewal system is provided by a first vendor and said second conditional access system is provided by a second vendor.

15. The content delivery system of claim 1, further comprising:
a second encryption renewal system;
wherein said first encryption renewal system transmits encryption data to said second encryption renewal system, said encryption data comprising information allowing said second encryption renewal system to authorize a third conditional access system to allow a second subscriber terminal to decrypt said pre-encrypted content.

16. The content delivery system of claim 15, wherein said first encryption renewal system transmits said encryption data to said second encryption renewal system using a certificate authentication protocol.

17. The content delivery system of claim 16, wherein said certificate authentication protocol is a SimulCrypt protocol.

18. The system of claim 1, wherein said second subscriber terminal comprises a set-top box.

19. A method for delivering pre-encrypted content to a first subscriber terminal, said method comprising:
generating said pre-encrypted content using a control word;
transmitting said pre-encrypted content to said first subscriber terminal; and
using an encryption renewal system associated with a first conditional access system to authorize a second conditional access system to allow said first subscriber terminal to decrypt said pre-encrypted content.

20. The method of claim 19, further comprising:
generating an encryption record corresponding to said control word; and
using said encryption record to generate an encrypted control word associated with said second conditional access system, said encrypted control word being an encrypted version of said control word used to pre-encrypt said content.

21. The method of claim 20, further comprising:
transmitting said encrypted control word and information for decrypting said encrypted control word to said second conditional access system;
decrypting said encrypted control word; and
generating an entitlement control message, said entitlement control message being an encrypted form of said control word.

22. The method of claim 21, further comprising generating a subscriber authorization message, said subscriber authorization message comprising information for decrypting said entitlement control message.

23. The method of claim 22, further comprising:
transmitting said entitlement control message and said subscriber authorization message to said first subscriber terminal; and
decrypting said pre-encrypted content using said entitlement control message and said subscriber authorization message.

24. The method of claim 22, wherein said subscriber authorization message is an entitlement management message.

25. The method of claim 20, further comprising storing said encryption record and said encrypted control word in a caching server.

26. The method of claim 25, further comprising:
periodically regenerating said encrypted control word associated with said second conditional access system;
transmitting said regenerated encrypted control word to said caching server; and
storing said regenerated encrypted control word in said caching server.

27. The method of claim 19, wherein said step of using said encryption renewal system to authorize said second conditional access system to allow said first subscriber terminal to decrypt said pre-encrypted content comprises using a key exchange protocol to communicate between said encryption renewal system and said second conditional access system.

28. The method of claim 27, wherein said key exchange protocol is a SimulCrypt protocol.

29. The method of claim 19, further comprising generating and transmitting a subscriber authorization message to said conditional access system, said subscriber authorization message authorizing said first subscriber terminal to decrypt said pre-encrypted content.

30. The method of claim 19, wherein said pre-encrypted content comprises pre-encrypted video-on-demand content.

31. A system for delivering pre-encrypted content to a first subscriber terminal, said system comprising:
means for generating said pre-encrypted content using a control word;
means for transmitting said pre-encrypted content to said first subscriber terminal; and
means for using an encryption renewal system associated with a first conditional access system to authorize a second conditional access system to allow said first subscriber terminal to decrypt said pre-encrypted content.

32. The system of claim 31, further comprising:
means for generating an encryption record corresponding to said control word; and
means for using said encryption record to generate an encrypted control word associated with said second conditional access system, said encrypted control word being an encrypted version of said control word used to pre-encrypt said content.

33. The system of claim 32, further comprising:
means for transmitting said encrypted control word and information for decrypting said encrypted control word to said second conditional access system;
means for decrypting said encrypted control word; and
means for generating an entitlement control message, said entitlement control message being an encrypted form of said control word.

34. The system of claim 33, further comprising means for generating a subscriber authorization message, said subscriber authorization message comprising information for decrypting said entitlement control message.

35. The system of claim 34, further comprising:
means for transmitting said entitlement control message and said subscriber authorization message to said first subscriber terminal; and
means for decrypting said pre-encrypted content using said entitlement control message and said subscriber authorization message.

36. The system of claim 32, further comprising means for storing said encryption record and said encrypted control word in a caching server.

37. The system of claim 36, further comprising:
means for periodically regenerating said encrypted control word associated with said second conditional access system;
means for transmitting said regenerated encrypted control word to said caching server; and
means for storing said regenerated encrypted control word in said caching server.

38. The system of claim 31, wherein said means for using said encryption renewal system to authorize said second conditional access system to allow said first subscriber terminal to decrypt said pre-encrypted content comprises means for using a key exchange protocol to communicate between said encryption renewal system and said second conditional access system.

39. The system of claim 38, wherein said key exchange protocol is a SimulCrypt protocol.

40. The system of claim 37, further comprising means for generating and transmitting a subscriber authorization message to said second conditional access system, said subscriber authorization message authorizing said first subscriber terminal to decrypt said pre-encrypted content.
